(19) United States
(12) Patent Application Publication
(10) Pub. No.: US 2024/0265298 A1
(43) Pub. Date: Aug. 8, 2024

(54) CONFLICT ANALYSIS BETWEEN OCCUPANCY GRIDS AND SEMANTIC SEGMENTATION MAPS

(71) Applicant: Motional AD LLC, Boston, MA (US)

(72) Inventor: Edouard Francois Marc Capellier, Singapore (SG)

(21) Appl. No.: 18/165,862

(22) Filed: Feb. 7, 2023

(51) Int. Cl. G06N 20/00

(52) U.S. Cl. CPC G06N 20/00

(57) ABSTRACT

Provided are methods, systems, and computer program products for programmatic detection of objects with an unknown or uncertain semantic class, and generation of a training data set for such objects that can facilitate further development of machine learning models trained to extract semantic information. Embodiments of the present disclosure can detect discrepancies between sensor data corresponding to multiple representations of an environment, and utilize the identified discrepancies to programmatically select a portion of the sensor data for use as a training data set, e.g., for input to a machine learning model.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a block diagram illustrating an example environment in which a system determines conflicts between occupancy grids and semantic maps and generates training examples;

FIG. 6 is a visualization that depicts an example segmentation map, an example occupancy grid, an example delta representation representing differences between the example segmentation map and the example occupancy grid, and an orthographic projection of a portion of sensor data corresponding to a discrepancy between the example segmentation map the example occupancy grid;

FIG. 7 is a flow diagram illustrating an example of a routine implemented by one or more processors to determine conflicts between occupancy grids and semantic maps and generate training examples.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Generally described, aspects of the present disclosure relate to programmatic generation of data sets supporting machine learning to extract semantic information from sensor data, such as data from a sensor of an autonomous vehicle. In the context of the present disclosure, such semantic information generally corresponds to an understanding of what types of object are depicted in sensor data. For example, whereas a computing device may naively represent an image as a set of pixels, semantic understanding of the image can classify sets of pixels as corresponding to a particular class of object (such as a human, a dog, cat, etc.). In the context of autonomous vehicles, semantic information may designate specific portions of sensor data as corresponding to a road, a car, a pedestrian, a bicycle, a crosswalk, or any number of other object categories. One can readily understand how an ability to distinguish between these types of objects-something that humans innately possess, but that computers do not—may be critical to the safe and effective operation of an autonomous vehicle.

One approach for programmatically providing semantic understanding of sensor data is to apply a machine learning (ML) model to the data. For example, a model, such as a deep convolutional neural network, may be trained on a data set that identifies a particular type of object within sensor data. Thereafter, the model may be fed new sensor data and tasked with identifying that type of object in the data. One problem with this approach is the need for rich, accurate training data. To reach effectiveness—and particularly a level of effectiveness required for safety-critical tasks like autonomous driving—a machine learning model often requires very large data sets, which are often difficult to generate. Moreover, generation of training data sets often depends on human expertise. For example, a human expert may identify a particular set of object classes that they subjectively believe is relevant to a certain task such as autonomous driving, and then generate one or more models trained to identify objects of each such class. This approach can be problematic in that the set of object classes selected may not capture all classes of objects encountered during the task. For example, an autonomous vehicle may encounter an object for which it has no corresponding machine learning model, thus inhibiting the vehicle from programmatically gaining semantic knowledge of the objects class. This, in turn, may hinder proper operation of the vehicle. For example, the vehicle may halt operation or operate more slowly than required, to ensure safety in the presence of the unknown object.

Embodiments of the present disclosure address the above-noted problems by providing for programmatic detection of objects with an unknown or uncertain semantic class, and generation of a training data set for such objects that can facilitate further development of machine learning models trained to extract semantic information. More specifically, embodiments of the present disclosure can detect discrepancies between sensor data corresponding to multiple representations of an environment, and utilize the identified discrepancies to programmatically select a portion of the sensor data for use as a training data set, e.g., for input to a machine learning model.

In one example, the present disclosure provides for comparison of an occupancy grid representing an area with a semantic segmentation map representing the area, as generated for example by use of a machine learning model. Generally described, an occupancy grid provides a representation of an area and a designation as to whether individual portions of the area are occupied by an object. For example, a 2-dimensional (2D) occupancy grid may correspond to a binary image, with individual pixels (or other predefined portions) designated as occupied (e.g., black or 1) or unoccupied (e.g., white or 0). Occupancy grids of other dimensionalities are similarly possible. Occupancy may be programmatically determined by an algorithm applied to sensor data. For example, in the context of an autonomous vehicle, sensor data may correspond to lidar data or other depth-sensing data, and a location may be indicated as occupied when an object is detected to satisfy pre-defined conditions (e.g., a pre-defined height, width, total size, etc.). In many instances, an occupancy grid is generated using a less complex algorithm than ML-derived segmentation maps. For example, generation of a grid may not require training, knowledge of specific object classes, or the like. Accordingly, the occupancy grid may in practice be more accurate than ML-derived segmentation maps. For example, an occupancy map may have a lower false positive rate, false negative rate, or both, than a corresponding ML model (e.g., as measured by comparison of accuracy of occupancy indications on one hand and object classification on the other). Moreover, an occupancy map, in providing binary indications, may avoid issues related to non-comprehensive types. That is, whereas perfectly accurate operation of a segmentation map may rely on a comprehensive knowledge of all possible object classes, an occupancy may be limited, by design, to two possible states (e.g., occupied or not). Somewhat similarly, because of the potential low complexity of algorithm used for occupancy map generation, occupancy maps may be considered “closer to” the raw data and more interpretable relative to complex ML models (which are often referred to as “black boxes” for the difficulty in interpreting how a model arrived at a given object classification). Occupancy maps may therefore be more reliable than semantic segmentation maps in many situations.

While occupancy maps have benefits relative to semantic segmentation maps as noted above, they also often incur drawbacks, such as an ability to semantically distinguish object types. Illustratively, a map may indicate an area is occupied, but fail to indicate whether the area is occupied by, for example, a car, a person, a plant, etc. Such details are often critical to safe and effective operation of autonomous vehicles.

Embodiments of the present disclosure can utilize the high accuracy of occupancy maps relative to segmentation maps to generate training data sets that, in turn, can improve the accuracy of segmentation maps. Specifically, as disclosed herein, a computing device can be configured to compare an occupancy map to a segmentation map to identify one or more portions of an environment for which the two representations disagree. In one embodiment, individual portions (e.g., pixels) of the segmentation map are classified as belonging to one of a set of classes. Each class of the set of classes may be designated as an occupying class or a non-occupying class. In the context of an autonomous vehicle, for example, an occupying class may indicate areas where the autonomous vehicle cannot drive, such as areas corresponding to other cars, pedestrians, bicycles, buildings, etc., while a non-occupying class may constitute drivable area, such as roads, crosswalks, intersections, and the like. A computing device (which may be included in the autonomous vehicle or external to such a vehicle) may compare representations of the area to identify portions, if any, where there is a discrepancy between the occupancy status as indicated by the occupancy map and the occupancy status as indicated by the class type in the segmentation map. For example, the computing device may determine that a particular portion of an area is designated as a non-occupying class in the segmentation map (e.g., roadway), but that the same portion of the area is designated as occupied in the occupancy map. In reality, this may reflect that the area is occupied by an object for which an ML model that generated the segmentation map is not trained; for example, the object may be one not typically found in a roadway (such as an office desk). Because the model was not trained to detect such an object, it may erroneously classify the area as another type of object (e.g., drivable roadway). As another example, a discrepancy may occur where there is a difference in confidence level between two representations. For example, individual portions of an occupancy grid and segmentation map may be associated with confidence levels (e.g., of being occupied on the one hand and of being a particular class on the other). A discrepancy may thus occur where an occupancy grid has a high confidence (e.g., above a given threshold) of a portion of an area having particular occupancy state and the segmentation map has a low confidence (e.g., below a given threshold) for the portion of the area.

Embodiments of the present disclosure provide a solution to this problem, by programmatically generating new training data for the ML model based on the discrepancy. For example, the computing device may extract a portion of the sensor data corresponding to the area and identify it as having a potentially improper class. This portion of sensor data may then be used to update the ML model, or train a new ML model, such that the class of the object is corrected if necessary. For example, the portion of sensor data, or appropriate representation of that sensor data, may be provided to a human analyst for labeling as a given class. Additionally or alternatively, the portion of sensor data may be programmatically labeled, such as by labeling the portion to correspond to a generic class (e.g. “obstacle,” “occupying object,” or the like). The labeled portion, potentially in combination with other labeled portions of sensor data obtained via these embodiments, may then be used to update an ML model, or train a new ML model, to correct label objects of the given class in future instances. In this manner, generation of subsequent segmentation maps is improved.

As will be appreciated by one of skill in the art in light of the present disclosure, the embodiments disclosed herein improve the ability of computing systems to conduct image or sensor data recognition, such as by identifying semantic information within sensor data. In particular, embodiments of the present disclosure enable programmatic generation of training data for use in machine vision applications, such as training machine learning algorithms to conduct semantic segmentation. Moreover, the presently disclosed embodiments address technical problems inherent within computing systems; specifically, the difficulty of programmatically recognizing semantic information within sensor data or representations thereof and the difficulty in identifying instances of specific semantic information within large quantities of sensor data. These technical problems are addressed by the various technical solutions described herein, including the comparison of multiple representations of an area to identify discrepancies, the programmatic extraction of sensor data corresponding to a discrepant area, the generation of a training data set including the extracted sensor data, and the use of the training data set to improve subsequent generation of area representations. Thus, the present disclosure represents an improvement on computing systems implementing machine vision and computing systems in general.

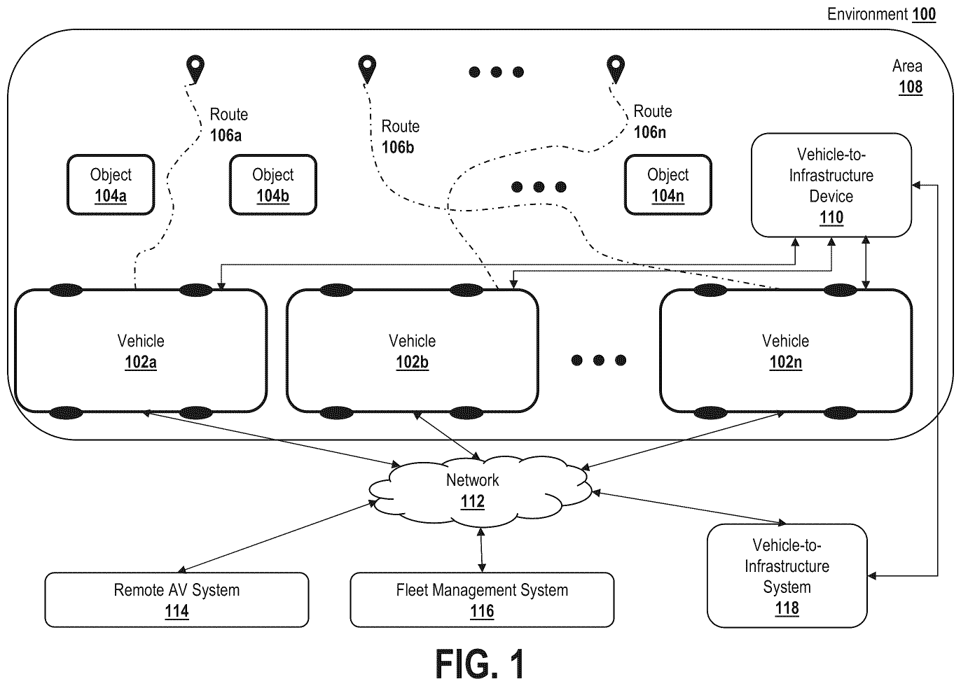

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

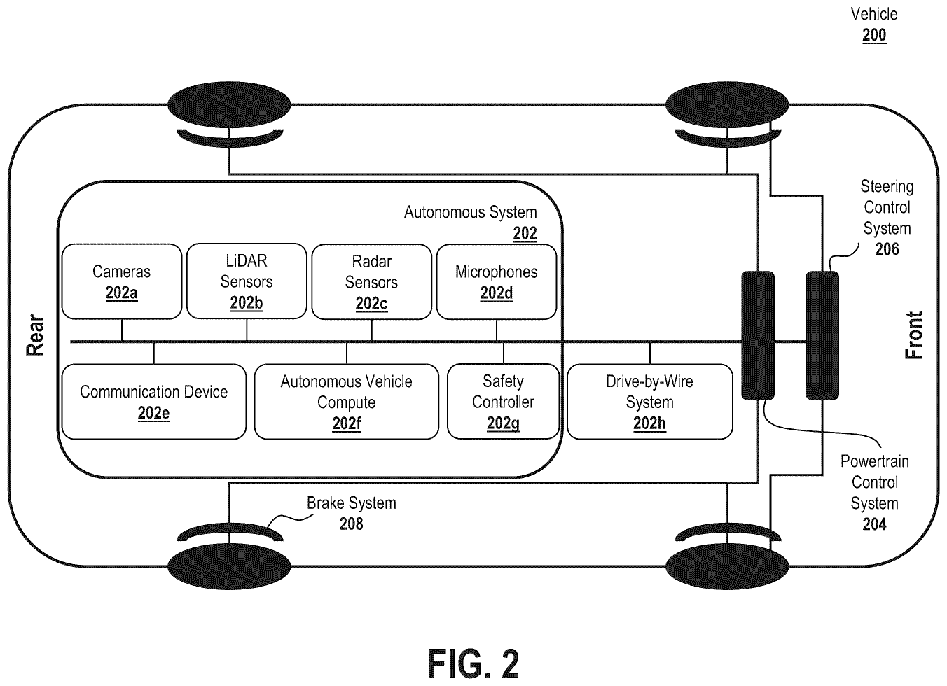

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

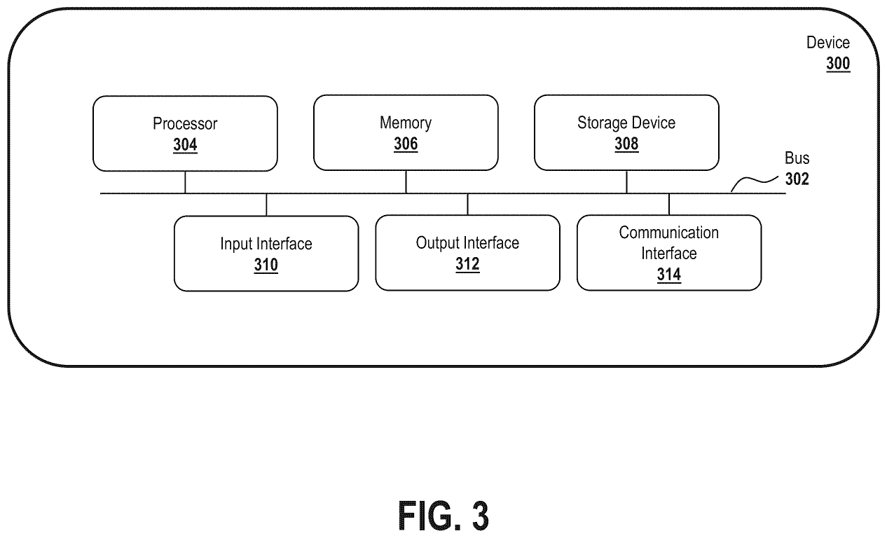

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data (TLD data) associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LIDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

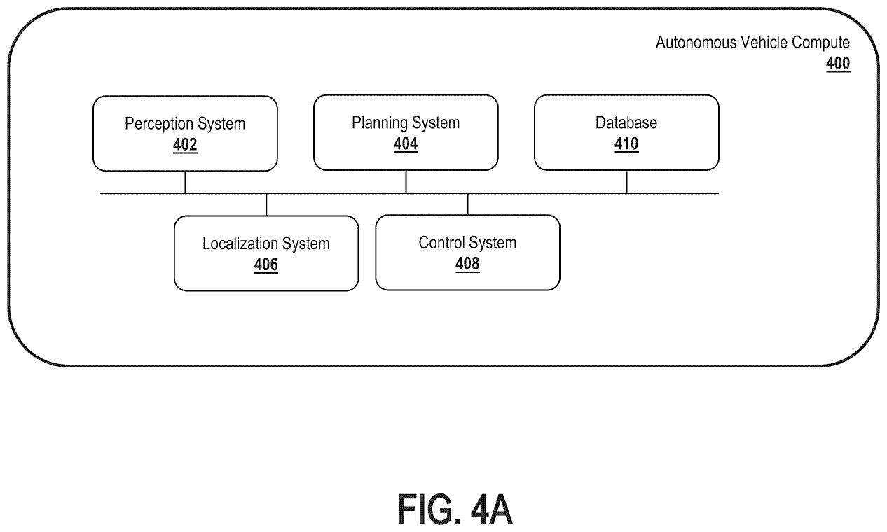

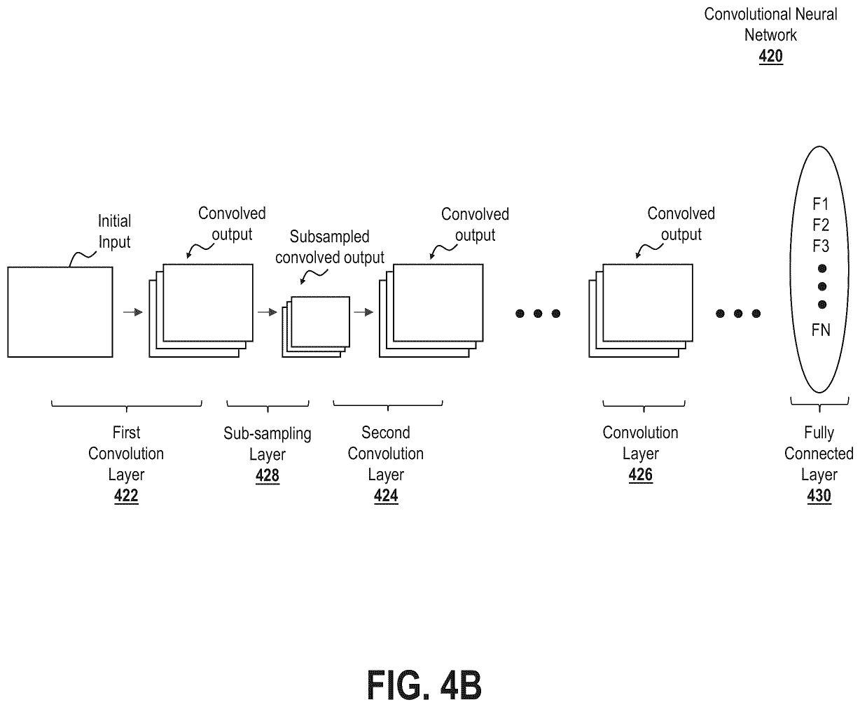

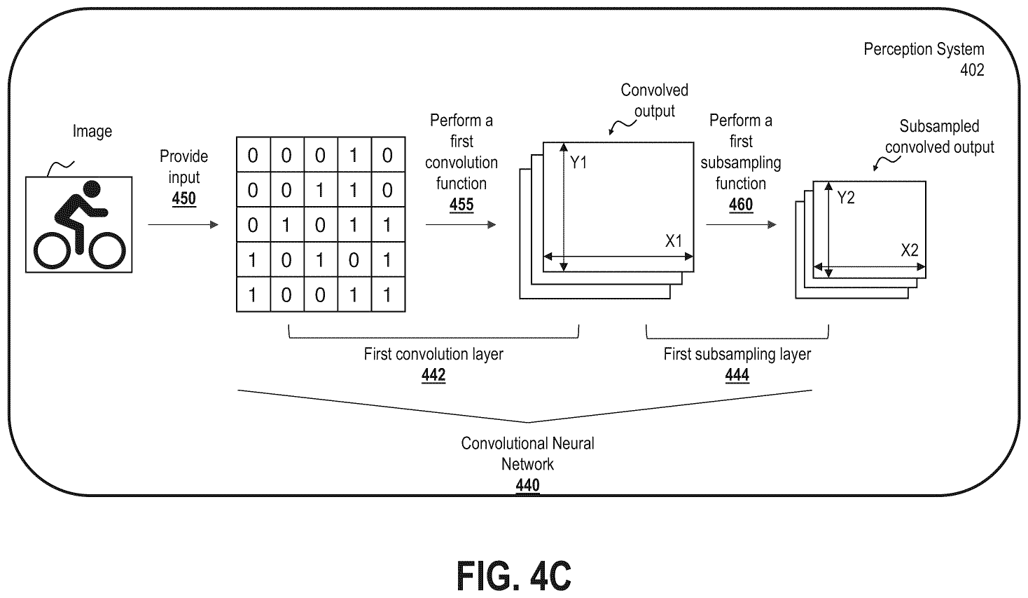

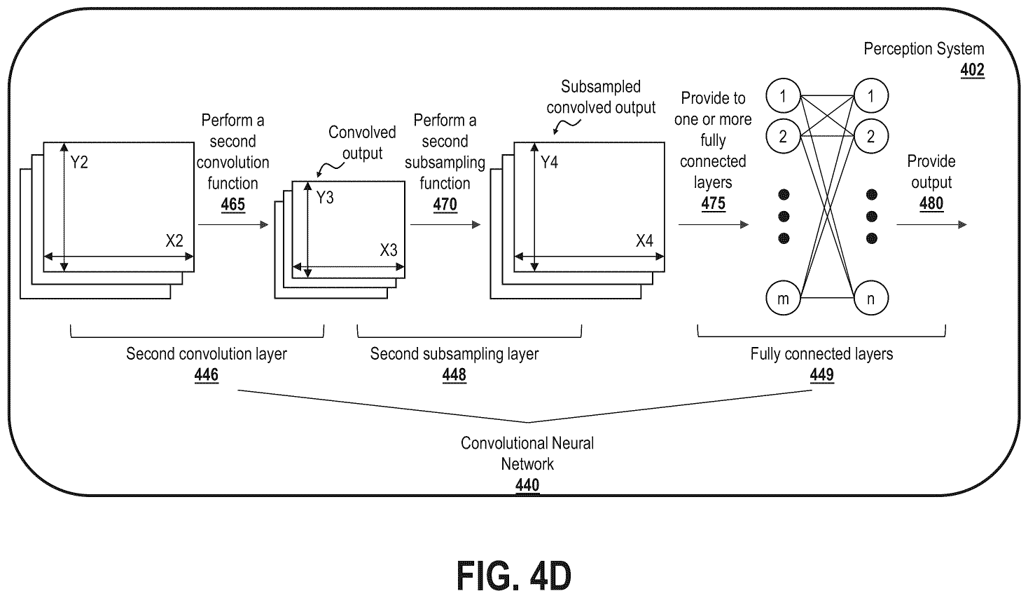

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LIDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Undetected Object Training Data Generation

As discussed above, it may be difficult to train a machine learning model, such as the CNNs described above, to accurately provide semantic information regarding sensor data, such as by identify objects within an image as a particular object class. Moreover, it may be difficult to programmatically detect when errors in semantic information exist, and to generate training data used to correct such errors.

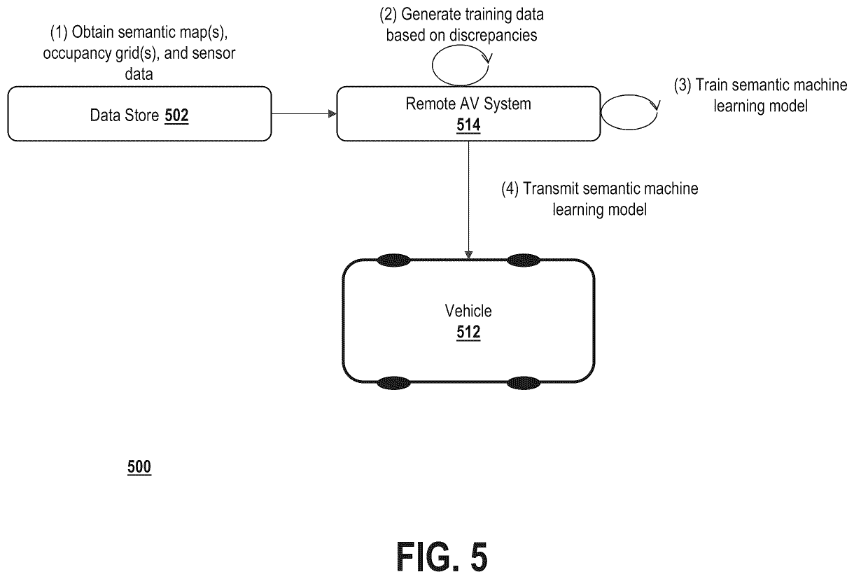

With reference to FIGS. 5-8, embodiments will be described enabling programmatic detection of errors in semantic information and generation of training data sets used to correct such errors. Specifically, embodiments will be described that utilize conflict analysis between different representations of an area, one of which includes semantic information, to detect expected errors in one of the representations, and extract a portion of the representation (or underlying sensor data) corresponding to the expected error, which portion may then be used as part of a training data set to improve subsequent generation of the representation. In one example, a first representation is a semantic segmentation map generated by operation of a machine learning model, such as those described above, and a second representation is an occupancy map. Comparison of the segmentation map to the occupancy map can enable a computing device to identify portions of the segmentation map that are classified as a non-occupying class, but which are identified in the occupancy map as an occupying class. The computing device may then extract portions of the sensor data used to generate the segmentation map, corresponding to an object that would be expected to represent an occupying class. These portions of the sensor data may then be used (e.g., without labeling, with human-generated labels, etc.) as part of a training data set to retune the machine learning model that generated the segmentation map, or to train a new model, such that the resulting model more successfully classifies similar objects in subsequent instances.

With reference to FIG. 5, illustrative interactions in an environment 500 will be described for determining discrepancies between occupancy grids and semantic maps and generating training examples. The environment 500 illustratively includes a remote AV system 514, which may correspond for example to the remote AV system 114 of FIG. 1, and a vehicle 512, which may correspond for example to the vehicle 200 of FIG. 2.

The interactions of FIG. 5 being at (1), where the remote AV system 514 obtains semantic maps and occupancy grids from a data store 502, which may correspond to any persistent or substantially persistent data store. The maps and grids may be grouped into pairs, each pair corresponding to a given a physical environment corresponding to a given physical area. As discussed above, the semantic map may provide semantic information regarding objects within the area, such as by classifying portions of the map (e.g., pixels, voxels, etc.) as corresponding to a particular type of object (e.g., road, sidewalk, crosswalk, intersection, car, pedestrian, bicycle, building, barrier, etc.). Types of objects may further be grouped into occupied or unoccupied types. For example, portions classified as pedestrians, bicycles, buildings, barriers, and the like may be considered occupied. In some instances, occupied class types may also be considered “non-drivable” areas. Conversely, roads, sidewalks, intersections, and crosswalks (and not otherwise classified with an occupied type) may be classified as non-occupied areas. In some instances, non-occupied areas may be considered “drivable” areas to indicate that a vehicle could physically traverse the area (though may be restricted from doing so for any variety of reasons). The occupancy grid may provide an indication of occupancy within the area, without providing semantic information. For example, the grid may include a matrix of binary indications, indicating for each portion of the grid whether the portion is occupied or unoccupied. As discussed above, the semantic map may be generated via a more complex or opaque process than the process used to generate the occupancy map. For example, generation of a semantic map may include processing sensor data through a convolutional neural network, such as those discussed above, while generation of the occupancy map may include processing sensor data through a non-learned (e.g., static) algorithm, such as detecting whether the sensor data identifies an object in the area above a threshold height.

In addition, at (1), the remove AV system 514 obtains all or part of the sensor data used to generate the semantic map and occupancy grid. As discussed above, each of the semantic map and the occupancy grid may be generated via processing of sensor data obtained by operation of a sensor in the area. For example, the sensor data may be obtained during operation of an autonomous vehicle in the area and processed (either by the vehicle or otherwise thereafter) to generate the semantic map and occupancy grid. Sensor data may include, for example, 2D imaging sensors (such as cameras), lidar, and radar, or combinations thereof. In one embodiment, each pair of semantic map and occupancy grid are generated from the same sensor data. In another embodiment, a semantic map and an occupancy grid in a given pair are generated via at least partially different sensor data. For example, an occupancy grid may be generated based solely on lidar data, while a semantic map is generated based on a combination of lidar and camera data, among other possible combinations and variations. As discussed below, a subset of the sensor data may be selected for inclusion in a training data set where a discrepancy exists between a portion of a segmentation map and a corresponding portion of an occupancy grid generated from such sensor data.

For purposes of FIG. 5, it is assumed that each pair of semantic map and occupancy grid are aligned to correspond to the same physical area (e.g., such that each location in the map has a known correspondence to a location in the occupancy grid, both of which reflect a particular location in the physical area). However, the remote AV system 514 may in some instances be configured to align the semantic map and an occupancy grid, such as by modifying a shape or size of one to align to the other, identifying sufficient similarities in the two maps to generate alignment (e.g., by identifying a threshold number of points in one map that correspond to points in another, where correspondence may be for example that point in respective maps indicate an occupancy or unoccupied state, such as via binary indication or class type). Further, it is assumed for the purposes of FIG. 5 that the semantic map and occupancy grid have a common dimensionality (e.g., 2 dimensions, 3 dimensions, etc.). However, the remote AV system 514 may in some embodiments be configured to modify a dimensionality of either or both the semantic map and the occupancy grid to place both representations into a common dimensionality. For example, the remove AV system 514 may reduce a dimensionality of either the semantic map or the occupancy grid to a pre-defined dimensionality, such as via projection of the higher-dimensionality representation onto a lower-dimensionality representation.

At interaction (2), the remote AV system 514 generates additional training data for training a machine learning model to generate semantic maps by identifying discrepancies between the obtained semantic map and occupancy grid pairs. As noted above, discrepancies may exist between these maps due for example to errors or failures of a machine learning model used to generate the semantic maps. Illustratively, such a model may misclassify an object that is actually an obstruction as a non-obstructing (non-occupying) class of object, despite being trained to classify objects of a particular class. As another example, such a model may fail to classify an object of a particular class as it was not trained to identify objects of the class. In either instance, misclassification may present problems to the same and effective operation of an autonomous vehicle.

In one embodiment, identification of discrepancies occurs on a portion-to-portion comparison of the semantic map and the occupancy grid, to determine any portions of the semantic map that are indicated to contain an object of with an occupancy class different from that indicated by the occupancy grid (e.g., an object of a non-occupying class type in a location indicated as occupied by the occupancy grid, or vice versa). In one embodiment, portions correspond to pixels of the respective representations, though other portion sizes (e.g., kernels of a given pixel dimensionality) may also be used. While embodiments are described herein with reference to pixels, other atomic units may be substituted where appropriate. For example, where the semantic map and occupancy grid are 3D representations, voxels may be used as an atomic unit.

Illustratively, the remove AV system 514 may first convert the semantic map to a binary map by modifying each pixel of the map into a binary value as indicated by whether the classification of the pixel is of an occupying or non-occupying class type. For example, all pedestrians, bicycles, buildings, barriers, and the like may be converted to a first value (e.g., 1) due to their being considered an occupying class type, while all roads, sidewalks, intersections, and crosswalks may be converted to a second value. The remote AV system 514 may then compare the converted binary representation of the semantic map with the occupancy grid to detect differences between the two representations of the environment (e.g., where one representation indicates a portion is occupied and the other does not). As a result, the remote AV system 514 may generate a delta representation reflecting those differences. For example, the delta representation may be a binary n-dimensional representation of the area (e.g., where n matches a dimensionality of the semantic map and occupancy grid) with individual portions of the delta representations, such as pixels or voxels, having a state of either “corresponding” or “not corresponding” to indicate whether the occupancy of the portion is the same (corresponding) across the segmentation map and the occupancy map or different (not corresponding).

The remote AV system 514 may then generate training data based on the discrepancies between each segmentation map and occupancy grid in a given pair, as indicated by the non-corresponding portions of the delta representation. In one embodiment, the remote AV system 514 training data corresponds to a portion of sensor data used to generate a segmentation map. For example, the remote AV system 514 may determine an area corresponding to a discrepancy, and determine a corresponding portion of the sensor data for that area. Illustratively, where the sensor data includes lidar data, the remote AV system 514 may extract from the lidar data all data points within a region of the discrepancy. Similarly, if sensor data includes camera data, remote AV system 514 may extract from 2D images pixels that capture a given area. Such extraction may in some cases include re-projecting data into different representations. For example, image data at a given point of view may be projected onto a 3D representation (and potentially then reduced into a 2D birds-eye-view representation) in order to determine which pixels of the image data capture a given location within an area.

Because the extracted data was potentially misclassified during generation of the segmentation map, the extracted data can be included within a training data set used to train a further machine learning model (or retrain an existing model) to better classify the sensor data. For example, the extracted sensor data may reflect data of an object with an uncommon class (e.g., furniture or other objects not typically expected in an operational area of an autonomous vehicle). As another example, the sensor data may reflect an object of a common class, which an existing model was trained to detect, and thus reflect a deficiency in that model that may be corrected via additional training.

In some embodiments, multiple discrepancies may be identified between different representations of an area. These discrepancies may correspond to a single object, or multiple objects. For example, where multiple portions of an area are discrepant between two representations, it may be that these portions correspond to a single larger object or multiple smaller objects. In one embodiment, clustering may be applied to discrepancies in order to group these discrepancies. For example, multiple areas where discrepancies are identified may be clustered based on connectedness within the delta representation. Any variety of clustering algorithms may be used. Illustratively, connected portions may be identified using connected component analysis. Each cluster may be considered a single expected object for purposes of generating training data, while distinct clusters may be considered as distinct objects. Accordingly, where a delta map indicates discrepancies in multiple unconnected areas, training data may be generated including the sensor data extracted for each area, with the sensor data for each area being treated as a single expected object for purposes of training.

In some instances, identified discrepancies may be filtered prior to inclusion in training data. For example, discrepancies may be filtered when the connected area of the discrepancy is less than a threshold size or dimensionality in one or more dimensions (e.g., less than a threshold width, height, length, etc.). As another example discrepancies may be filtered based on sensor blockage. For example, where a discrepancy is identified in an area for which a line-of-sight based sensor, such as lidar, does not have visibility (e.g., behind a blockage object), the discrepancy may be omitted for purposes of generating training data.

In one embodiment, each object within training data (e.g., each set of sensor data for a connected area of discrepancy) is programmatically labeled. For example, where a discrepancy occurs due to the occupancy map indicating occupancy where the semantic map does not, an object may be labeled as a generic occupying class, such that a machine learning model may be trained to detect generic occupying objects without assigning a more specific semantic class to the object. Where a discrepancy occurs due to the occupancy map indicating non-occupancy where the semantic map indicates an object of an occupying class type, and object may be labeled as a generic non-occupying class, such that a machine learning model may be trained to detect generic non-occupying objects without assigning a more specific semantic class to the object. In another embodiment, each object within the training data is labeled with a semantic class. For example, the sensor data of each object may be provided to a human operator, which identifies the object from the sensor and labels the data with an appropriate object class having an appropriate occupancy class type.

While the above description relates to discrepancies between occupancy type (e.g., areas indicated as occupied in one representation and not another), some embodiments of the present disclosure may additionally or alternatively identify discrepancies based on confidence values of different representations. Illustratively, a discrepancy may be identified where a first representation indicates that an area is occupied with a high confidence (e.g., above a first threshold confidence), while another representation has a lower confidence (e.g., below the first threshold or another threshold) that the area is occupied. Similarly, a discrepancy may be identified where a first representation indicates that an area is unoccupied with a high confidence (e.g., above a first threshold confidence), while another representation has a lower confidence (e.g., below the first threshold or another threshold) that the area is unoccupied.

Thereafter, at (3), the remote AV system 514 utilizes the labeled training data, independently or in conjunction with additional training data, to train a semantic machine learning model to recognize the objects identified within the training data. Illustratively, the training data may be used to train a new machine learning model, or used to update an existing machine learning model (e.g., as used to generate the semantic maps in which discrepancies were identified). In one embodiment, a single semantic machine learning model is trained using the training data. In another embodiment, multiple semantic machine learning models are trained. For example, a different model may be trained to identify each label of object within the training data.

At (4), the remote AV system 514 can then transmit the semantic machine learning model to a vehicle 512. Because the model or models has been trained on sensor data that led to discrepancies in the past instance, and because the labels applied to the sensor data may avoid such discrepancies (e.g., by labeling the sensor data as an occupying or non-occupying class type), the models can be expected to have improved accuracy relative to those models used to generate the segmentation maps in which discrepancies were detected. Thus, the vehicle 512 may utilize the model to generate subsequent segmentation maps during operation of the vehicle 512, providing for safer and more effective operation.

The interactions of FIG. 5 may illustratively be repeated. For example, during operation of the vehicle 512, additional sensor data may be collected and used to generate segmentation maps and occupancy grids that are respectively stored in the data store 502, which data may then be used during subsequent iterations of the interactions of FIG. 5. Thus, the interactions of FIG. 5 may be used to iteratively improve performance of machine learning models interpreting sensor data, which may in turn improve various processes reliant on such models, such as operation of autonomous vehicle.

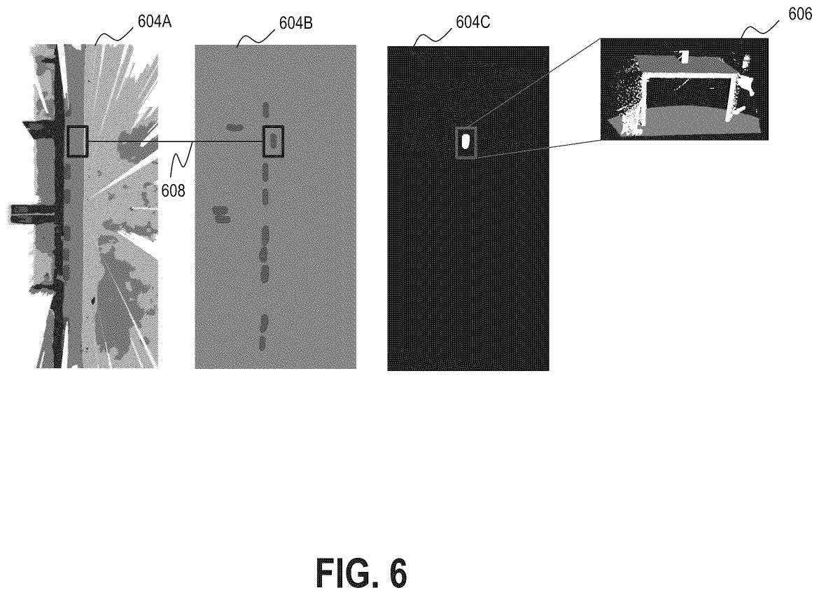

The interactions of FIG. 5 may be better understood with reference to the illustrative visualizations of FIG. 6, which depict an example segmentation map 604A, an example occupancy grid 604B, and an example delta representation 604C, each of which provide a different representation of a given environment and area. In addition, FIG. 6 depicts, as an orthographic projection 606, a portion of sensor data corresponding to a discrepancy between the segmentation map 604A the example occupancy grid 604B.

As can be seen in FIG. 6, the segmentation map 604A is a birds-eye-view representation of an area, with coloration indicating locations and classes of objects in the area. Specifically, in the segmentation map 604A, blue objects illustratively represent occupying object classes, while the remaining colors illustratively represent non-occupying object classes (e.g., roads, grass, lane dividers, etc.). The segmentation map 604A is illustratively generated during operation of an autonomous vehicle in the area, such as by lidar scan data obtained at the vehicle (alone or in combination with other sensor data).

Similarly, the occupancy grid 604B provides another birds-eye-view representation of the area. However, rather than provide semantic information regarding objects in the area, the occupancy map 604B is a binary image indicating that particular portions of the area are either occupied or non-occupied. Specifically, in FIG. 6, the darker areas of the occupancy grid 604B are indicated as occupied, with remaining areas indicated as unoccupied.

As shown in FIG. 6, a discrepancy exists between the segmentation map 604A and occupancy grid 604B, as indicated by element 608. Specifically, while occupancy map 604B identifies the location of element 608 on the grid 604B (i.e., the left-hand box of element 608) as occupied, the segmentation map 604A identifies the corresponding location of element 608 on the map 604A (i.e., the right-hand box of element 608, which is the same physical location as element 608 on the grid 604B) as an object of a non-occupying class (e.g., a roadway). Accordingly, a discrepancy exists between the map 604A and the grid 604B, as indicated by the delta representation 604C. In accordance with the description above, the delta representation 604C may be created, for example, by conversion of the segmentation map 604A into a binary representation according to whether each object class is an occupying or non-occupying type, along with a comparison of that binary representation to the grid 604B. For example, the delta representation may be created by modifying the segmentation map 604A such that blue areas are a positive value while other areas are a zero value, and then comparing the resulting binary representation to the grid 604B. For simplicity, a single discrepancy, corresponding to the location indicated by element 608, is shown in the delta representation 604C. In practice, multiple discrepancies may exist between a segmentation map 604A and an occupancy grid 604B.

As discussed above, this discrepancy can result, for example, from inaccuracy or error in a machine learning model used to generate the segmentation map 604A. Illustratively, the object at the location indicated by element 608 may be of an object class that the model was not trained to detect. Thus, the segmentation map 604A erroneously classifies the object as in a non-occupying object class.

To address this error or inaccuracy, a system may generate training data for an area in which there is a discrepancy. Specifically, a system may obtain sensor data used to generate the segmentation map 604A, and extract from the sensor data a portion corresponding to the location of the discrepancy. One illustration of such sensor data is shown in FIG. 6 as orthographic projection 606. Specifically, orthographic projection 606 represents a projection of lidar data corresponding the physical area represented by element 608. In FIG. 6, the orthographic projection 606 illustratively represents a office desk, which may be a class of element that the model which generated the segmentation map 604A was not trained to detect, thus explaining why the object was not classified correctly within the map 604A. However, by retraining the model, or training a new model using the sensor data, a new segmentation map may be generated that more correctly identifies the object. For example, the sensor data visualized in the orthographic projection 606 may be labeled (e.g., programmatically or by human operation) as an object class (e.g., generic occupying object, furniture, etc.), such that a model can be trained to recognize objects of the class from sensor data. Accordingly, generation of training data as described herein can improve operation of such models and systems that rely on these models, such as autonomous vehicles.

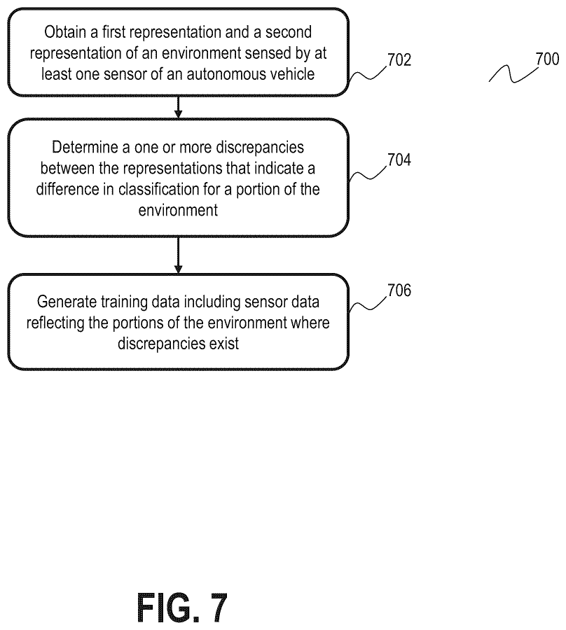

With reference to FIG. 7, an illustrative routine 700 will be described for generation of a training data set for machine learning models based on identification of discrepancies between multiple representations of an environment. The routine 700 may be implemented, for example, by the remote AV system 514 of FIG. 5.

The routine 700 begins at block 702, where the remote AV system 514 obtains a first and a second representation of an environment. The first and second representations may be generated based on sensor data obtained from one or more sensors in the environment. For example, the representations may be generated by operation of sensors on an autonomous vehicle, and reflect an environment in which the vehicle is navigating. As noted above, the sensors can include, for example, cameras, lidar sensors, radar sensors, or the like. Each representation can include one or more classifications for portions of the environment. For example, a representation may include a binary indication of whether individual portions of the environment are occupied, such as in the form of an occupancy grid. In another example, a representation may include a classification for individual portions of the environment from multiple potential classes. The representations may be based on the same sensor data, partially overlapping sensor data, or different sensor data. Moreover, the representations may be generated via different processes. For example, one representation may be generated based on a learned, opaque algorithm such as an applied machine learning model, while another may be generated based on a non-learned algorithm, such as a static rule-based algorithm. For purposes of FIG. 7, the representations are assumed to represent the same view of the environment and to be aligned with respect to that view. For example, both representations may be 2D, top down, birds-eye-views of the environment with a similar granularity. However, the routine 700 may also be modified to include modification of either or both representations to place both representations in the same point of view and to align the representations. For example, the remove AV system 514 may be configured to modify a dimensionality of either or both representations or recast one point of view into another (e.g., by projection). The remote AV system 514 may further be configured to align the representations, such as identifying corresponding locations in both representations and transforming one or both representations to achieve alignment.

At block 704, the remote AV system 514 determines one or more discrepancies between the representations, each of which indicate a difference in classification for a portion of the environment. Illustratively, where the first representation is an occupancy grid and the second representation is a segmentation map, a discrepancy may exist where the occupancy grid indicates that an area is occupied while the segmentation map indicates that the area is of a non-occupying class. Similarly, a discrepancy may exist where the occupancy grid indicates that an area is unoccupied while the segmentation map indicates that the area is of an occupying class. Still further, a discrepancy may exist where a difference in confidence for a classification exists between a first representation and a second representation, such as the first representation indicating an area is occupied with high confidence and a second representation not having sufficiently high confidence that the area is occupied.

As discussed above, detection of discrepancies may occur for example by generating a binary representation of a multi-class representation such as a segmentation map, with binary values indicating whether a corresponding classification of an area on the segmentation map is an occupying or non-occupying type classification. Detection of discrepancies may further occur based on generating a delta representation indicating where elements of the first representation and second representation do not agree (e.g., where an occupancy grid has different values than a binary representation of a segmentation map).

At block 706, the remote AV system 514 generates training data including sensor data reflecting portions of the environment where discrepancies exist. For example, the remote AV system 514 may extract from a full set of sensor data (e.g., a full lidar scan) that data that pertains to a physical area where a discrepancy was detected. As discussed above, this data may then be used to train subsequent machine learning models such that the discrepancy is less likely to occur in subsequent scans. For example, the data may be programmatically labeled based on a classification of the relevant sensor data in a more-trusted representation of the two representations. Illustratively, where an occupancy grid is more trusted than a segmentation map, and the occupancy grid indicates that the physical area reflected in the extracted sensor data is occupied, the sensor data may be programmatically labeled as occupied. As another example, the data may be labeled based on manual review. For example, the sensor data may be presented to a human operator and a label may be applied to the area based on human perception of the sensor data.

As noted above, in some embodiments sensor data may be grouped in the training data to correspond to expected objects in the environment. Illustratively, a clustering algorithm, such as connected component analysis, may be applied to the discrepancies (e.g., as reflected in a delta representation), and sensor data may be grouped based on corresponding clusters (e.g., with data representing each cluster corresponding to a single expected object) to result in discrepancy groups, each discrepancy group corresponding to an entry in the training data se. For example, where discrepancies exist in a connected physical area of 6 feet by 10 feet (e.g., the area of a small car), sensor data for the area may be grouped to enable the object to be identified and learned from. The labeling discussed above may illustratively occur on the basis of such groups. For example, a computing device may programmatically label a set of sensor data corresponding to a discrepancy group as an occupying or non-occupying object, a human operator may review sensor data for a given discrepancy group to label the object shown in the sensor data (e.g., a car), etc.

In addition, as noted above, training data may in some cases be generated based on less than all discrepancies identified in an environment. For example, discrepancies may be filtered out based on criteria such as total size (e.g., total area), dimensionality requirements (e.g., minimum or maximum height, width, length, etc.), sensor visibility (e.g., to avoid data in areas where a sensor is blocked), etc.

The routine 700 may then end. As discussed above, the training data generated by the routine 700 may illustratively be used to retrain an existing machine learning model, or to train a new machine learning model, thereby increasing the accuracy of such a model. The training data as generated by the routine 700 may be particularly desirable for training purposes, as the data may correspond to difficult to classify data, as indicated by the data resulting in a discrepancy between the two representations. For example, the data may correspond to difficult-to-classify or not-yet-seen object classes. The increased accuracy of such models can further improve the performance of computing systems that rely on these models, such as autonomous vehicles. For example, by more accurately perceiving and classifying objects in sensor data, an autonomous vehicle may navigate the environment more safely and efficiently.

Various example embodiments of the disclosure can be described by the following clauses:
Clause 1. A method implemented by at least one processor of a computing device, the method comprising:
   obtaining, by the at least one processor, a first representation and a second representation of an environment, wherein the environment is sensed by at least one sensor of an autonomous vehicle, and wherein the first representation and the second representation are generated based on sensor data from the at least one sensor;
   determining, by the at least one processor, one or more discrepancies between the first representation and the second representation, each discrepancy of the one or more discrepancies corresponding to difference in classification of a portion of the environment as indicated within the respective first representation and second representation;
   generating, by the at least one processor, a training data set including, for each discrepancy of the one or more discrepancies, a subset of the sensor data reflecting the portion of the environment at which the discrepancy exists.
Clause 2. The method of clause 1, wherein the first representation is generated by application of a machine learning model to the sensor data, and wherein the method further comprises retraining the machine learning model based at least partly on the training data set.
Clause 3. The method of clause 2, further comprising transmitting, by the at least one processor, the retrained machine learning model to at least one autonomous vehicle, wherein the at least one autonomous vehicle uses the retrained machine learning model to infer object classifications of objects based on additional sensor data.
Clause 4. The method of any of clauses 1-3, wherein the first representation is a semantic segmentation map of the environment and the second representation is an occupancy grid of the environment.
Clause 5. The method of any of clauses 1-4, wherein generating the training data set comprises clustering the one or more discrepancies into one or more discrepancy groups, each discrepancy group corresponding to an entry in the training data set.
Clause 6. The method of clause 5, wherein generating the training data set further comprises programmatically labeling each of the one or more discrepancy groups based on a classification, within at least one of the first or second representations, of the portion of the environment at which the discrepancy exists.
Clause 7. The method of any of clauses 1-6, wherein the difference in classification corresponds to a difference in confidence for classification of the portion of the environment in the first representation and confidence for classification of the portion of the environment in the second representation.
Clause 8. The method of any of clauses 1-7, wherein the first representation is generated by passing the sensor data through a model generated via application of machine learning to additional sensor data, and wherein the second representation is generated by application of a non-machine-learned algorithm to the sensor data.
Clause 9. The method of any of clauses 1-8, wherein determining the one or more discrepancies between the first representation and the second representation includes:
   comparing corresponding elements of the first representation and the second representation, wherein a first particular element of the first representation corresponds to a second particular element of the second representation; and
   based on a determination that the first particular element indicates the first particular element is not occupied and the second particular element indicates that the second element is occupied, identifying a difference in classification between the first particular element and the second particular element.
Clause 10. The method of any of clauses 1-9 further comprising aligning, by the at least one processor, the first representation with the second representation.
Clause 11. The method of any of clauses 1-10, wherein the first representation labels portions of the environment as corresponding to a class of a plurality of classes, and wherein determining the one or more discrepancies comprises generating a binary representation of the first representation by representing portions of the environment labeled as a first subset of the plurality of classes with a first value and representing portions of the environment labeled as a second subset of the plurality of classes with a second value.
Clause 12. The method of clause 11, wherein the first subset of the plurality of classes includes occupying-type classes, and wherein the second subset of the plurality of classes includes non-occupying-type classes.
Clause 13. The method of any of clauses 1-12, further comprising filtering the one or more discrepancies to remove at least one discrepancy from the one or more discrepancies, the at least one discrepancy satisfying removal criteria including one or more of a minimum size, a minimum dimensionality, or a minimum visibility from a point of view of the at least one sensor.
Clause 14. A system comprising:
   a data store storing computer-executable instructions; and
   a processor configured to execute the computer-executable instructions, wherein execution of the computer-executable instructions causes the system to:
      obtain a first representation and a second representation of an environment, wherein the environment is sensed by at least one sensor of an autonomous vehicle, and wherein the first representation and the second representation are generated based on sensor data from the at least one sensor;
      determining one or more discrepancies between the first representation and the second representation, each discrepancy of the one or more discrepancies corresponding to difference in classification of a portion of the environment as indicated within the respective first representation and second representation;
      generating a training data set including, for each discrepancy of the one or more discrepancies, a subset of the sensor data reflecting the portion of the environment at which the discrepancy exists.
Clause 15. The system of clause 14, wherein the first representation is generated by application of a machine learning model to the sensor data, and wherein the execution of the computer-executable instructions causes the system retrain the machine learning model based at least partly on the training data set.
Clause 16. The system of clause 15, further comprising transmitting, by the at least one processor, the retrained machine learning model to at least one autonomous vehicle, wherein the at least one autonomous vehicle uses the retrained machine learning model to infer object classifications of objects based on additional sensor data.
Clause 17. The system of any of clauses 14-16, wherein the first representation is a semantic segmentation map of the environment and the second representation is an occupancy grid of the environment.
Clause 18. The system of any of clauses 14-17, wherein generating the training data set comprises clustering the one or more discrepancies into one or more discrepancy groups, each discrepancy group corresponding to an entry in the training data set.
Clause 19. The system of clause 18, wherein generating the training data set further comprises programmatically labeling each of the one or more discrepancy groups based on a classification, within at least one of the first or second representations, of the portion of the environment at which the discrepancy exists.
Clause 20. The system of any of clauses 14-19, wherein the difference in classification corresponds to a difference in confidence for classification of the portion of the environment in the first representation and confidence for classification of the portion of the environment in the second representation.
Clause 21. The system of any of clauses 14-20, wherein the first representation is generated by passing the sensor data through a model generated via application of machine learning to additional sensor data, and wherein the second representation is generated by application of a non-machine-learned algorithm to the sensor data.
Clause 22. The system of any of clauses 14-21, wherein determining the one or more discrepancies between the first representation and the second representation includes:
   comparing corresponding elements of the first representation and the second representation, wherein a first particular element of the first representation corresponds to a second particular element of the second representation; and
   based on a determination that the first particular element indicates the first particular element is not occupied and the second particular element indicates that the second element is occupied, identifying a difference in classification between the first particular element and the second particular element.
Clause 23. The system of any of clauses 14-22 further comprising aligning, by the at least one processor, the first representation with the second representation.
Clause 24. The system of any of clauses 14-23, wherein the first representation labels portions of the environment as corresponding to a class of a plurality of classes, and wherein determining the one or more discrepancies comprises generating a binary representation of the first representation by representing portions of the environment labeled as a first subset of the plurality of classes with a first value and representing portions of the environment labeled as a second subset of the plurality of classes with a second value.
Clause 25. The system of clause 24, wherein the first subset of the plurality of classes includes occupying-type classes, and wherein the second subset of the plurality of classes includes non-occupying-type classes.
Clause 26. The system of any of clauses 14-25, further comprising filtering the one or more discrepancies to remove at least one discrepancy from the one or more discrepancies, the at least one discrepancy satisfying removal criteria including one or more of a minimum size, a minimum dimensionality, or a minimum visibility from a point of view of the at least one sensor.
Clause 27. One or more non-transitory computer-readable storage media storing computer-executable instructions that, when executed by a computing system comprising a processor, cause the computing system to:
   obtain a first representation and a second representation of an environment, wherein the environment is sensed by at least one sensor of an autonomous vehicle, and wherein the first representation and the second representation are generated based on sensor data from the at least one sensor;
   determining one or more discrepancies between the first representation and the second representation, each discrepancy of the one or more discrepancies corresponding to difference in classification of a portion of the environment as indicated within the respective first representation and second representation;
   generating a training data set including, for each discrepancy of the one or more discrepancies, a subset of the sensor data reflecting the portion of the environment at which the discrepancy exists.
Clause 28. The one or more non-transitory computer-readable storage media of clause 27, wherein the first representation is generated by application of a machine learning model to the sensor data, and wherein execution of the computer-executable instructions causes the system to retrain the machine learning model based at least partly on the training data set.
Clause 29. The one or more non-transitory computer-readable storage media of clause 28, further comprising transmitting, by the at least one processor, the retrained machine learning model to at least one autonomous vehicle, wherein the at least one autonomous vehicle uses the retrained machine learning model to infer object classifications of objects based on additional sensor data.
Clause 30. The one or more non-transitory computer-readable storage media of any of clauses 27-29, wherein the first representation is a semantic segmentation map of the environment and the second representation is an occupancy grid of the environment.
Clause 31. The one or more non-transitory computer-readable storage media of any of clauses 27-30, wherein generating the training data set comprises clustering the one or more discrepancies into one or more discrepancy groups, each discrepancy group corresponding to an entry in the training data set.
Clause 32. The one or more non-transitory computer-readable storage media of clause 31, wherein generating the training data set further comprises programmatically labeling each of the one or more discrepancy groups based on a classification, within at least one of the first or second representations, of the portion of the environment at which the discrepancy exists.
Clause 33. The one or more non-transitory computer-readable storage media of any of clauses 27-32, wherein the difference in classification corresponds to a difference in confidence for classification of the portion of the environment in the first representation and confidence for classification of the portion of the environment in the second representation.
Clause 34. The one or more non-transitory computer-readable storage media of any of clauses 27-33, wherein the first representation is generated by passing the sensor data through a model generated via application of machine learning to additional sensor data, and wherein the second representation is generated by application of a non-machine-learned algorithm to the sensor data.
Clause 35. The one or more non-transitory computer-readable storage media of any of clauses 27-34, wherein determining the one or more discrepancies between the first representation and the second representation includes:
   comparing corresponding elements of the first representation and the second representation, wherein a first particular element of the first representation corresponds to a second particular element of the second representation; and
   based on a determination that the first particular element indicates the first particular element is not occupied and the second particular element indicates that the second element is occupied, identifying a difference in classification between the first particular element and the second particular element.
Clause 36. The one or more non-transitory computer-readable storage media of any of clauses 27-35 further comprising aligning, by the at least one processor, the first representation with the second representation.
Clause 37. The one or more non-transitory computer-readable storage media of any of clauses 27-36, wherein the first representation labels portions of the environment as corresponding to a class of a plurality of classes, and wherein determining the one or more discrepancies comprises generating a binary representation of the first representation by representing portions of the environment labeled as a first subset of the plurality of classes with a first value and representing portions of the environment labeled Clause as a second subset of the plurality of classes with a second value.
Clause 38. The one or more non-transitory computer-readable storage media of clause 37, wherein the first subset of the plurality of classes includes occupying-type classes, and wherein the second subset of the plurality of classes includes non-occupying-type classes.
Clause 39. The one or more non-transitory computer-readable storage media of any of clauses 27-38, further comprising filtering the one or more discrepancies to remove at least one discrepancy from the one or more discrepancies, the at least one discrepancy satisfying removal criteria including one or more of a minimum size, a minimum dimensionality, or a minimum visibility from a point of view of the at least one sensor.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

What is claimed is:

1. A method implemented by at least one processor of a computing device, the method comprising:
obtaining, by the at least one processor, a first representation and a second representation of an environment, wherein the environment is sensed by at least one sensor of an autonomous vehicle, and wherein the first representation and the second representation are generated based on sensor data from the at least one sensor;
determining, by the at least one processor, one or more discrepancies between the first representation and the second representation, each discrepancy of the one or more discrepancies corresponding to difference in classification of a portion of the environment as indicated within the respective first representation and second representation;
generating, by the at least one processor, a training data set comprising, for each discrepancy of the one or more discrepancies, a subset of the sensor data reflecting the portion of the environment at which the discrepancy exists.

2. The method of claim 1, wherein the first representation is generated by application of a machine learning model to the sensor data, and wherein the method further comprises retraining the machine learning model based at least partly on the training data set.

3. The method of claim 2, further comprising transmitting, by the at least one processor, the retrained machine learning model to at least one autonomous vehicle, wherein the at least one autonomous vehicle uses the retrained machine learning model to infer object classifications of objects based on additional sensor data.

4. The method of claim 1, wherein the first representation is a semantic segmentation map of the environment and the second representation is an occupancy grid of the environment.

5. The method of claim 1, wherein generating the training data set comprises clustering the one or more discrepancies into one or more discrepancy groups, each discrepancy group corresponding to an entry in the training data set.

6. The method of claim 5, wherein generating the training data set further comprises programmatically labeling each of the one or more discrepancy groups based on a classification, within at least one of the first or second representations, of the portion of the environment at which the discrepancy exists.

7. The method of claim 1, wherein the difference in classification corresponds to a difference in confidence for classification of the portion of the environment in the first representation and confidence for classification of the portion of the environment in the second representation.

8. The method of claim 1, wherein the first representation is generated by passing the sensor data through a model generated via application of machine learning to additional sensor data, and wherein the second representation is generated by application of a non-machine-learned algorithm to the sensor data.

9. The method of claim 1, wherein determining the one or more discrepancies between the first representation and the second representation comprises:
comparing corresponding elements of the first representation and the second representation, wherein a first particular element of the first representation corresponds to a second particular element of the second representation; and
based on a determination that the first particular element indicates the first particular element is not occupied and the second particular element indicates that the second element is occupied, identifying a difference in classification between the first particular element and the second particular element.

10. The method of claim 1 further comprising aligning, by the at least one processor, the first representation with the second representation.

11. The method of claim 1, wherein the first representation labels portions of the environment as corresponding to a class of a plurality of classes, and wherein determining the one or more discrepancies comprises generating a binary representation of the first representation by representing portions of the environment labeled as a first subset of the plurality of classes with a first value and representing portions of the environment labeled as a second subset of the plurality of classes with a second value.

12. The method of claim 11, wherein the first subset of the plurality of classes comprises occupying-type classes, and wherein the second subset of the plurality of classes comprises non-occupying-type classes.

13. The method of claim 1, further comprising filtering the one or more discrepancies to remove at least one discrepancy from the one or more discrepancies, the at least one discrepancy satisfying removal criteria comprising one or more of a minimum size, a minimum dimensionality, or a minimum visibility from a point of view of the at least one sensor.

14. A system comprising:
a data store storing computer-executable instructions; and
a processor configured to execute the computer-executable instructions, wherein execution of the computer-executable instructions causes the system to:
obtain a first representation and a second representation of an environment, wherein the environment is sensed by at least one sensor of an autonomous vehicle, and wherein the first representation and the second representation are generated based on sensor data from the at least one sensor;
determining one or more discrepancies between the first representation and the second representation, each discrepancy of the one or more discrepancies corresponding to difference in classification of a portion of the environment as indicated within the respective first representation and second representation;
generating a training data set comprising, for each discrepancy of the one or more discrepancies, a subset of the sensor data reflecting the portion of the environment at which the discrepancy exists.

15. The system of claim 14, wherein the first representation is generated by application of a machine learning model to the sensor data, and wherein the execution of the computer-executable instructions causes the system to retrain the machine learning model based at least partly on the training data set.

16. The system of claim 14, wherein generating the training data set comprises clustering the one or more discrepancies into one or more discrepancy groups, each discrepancy group corresponding to an entry in the training data set.

17. The system of claim 14, wherein determining the one or more discrepancies between the first representation and the second representation comprises:
comparing corresponding elements of the first representation and the second representation, wherein a first particular element of the first representation corresponds to a second particular element of the second representation; and
based on a determination that the first particular element indicates the first particular element is not occupied and the second particular element indicates that the second element is occupied, identifying a difference in classification between the first particular element and the second particular element.

18. One or more non-transitory computer-readable storage media storing computer-executable instructions that, when executed by a computing system comprising a processor, cause the computing system to:
obtain a first representation and a second representation of an environment, wherein the environment is sensed by at least one sensor of an autonomous vehicle, and wherein the first representation and the second representation are generated based on sensor data from the at least one sensor;
determining one or more discrepancies between the first representation and the second representation, each discrepancy of the one or more discrepancies corresponding to difference in classification of a portion of the environment as indicated within the respective first representation and second representation;
generating a training data set comprising, for each discrepancy of the one or more discrepancies, a subset of the sensor data reflecting the portion of the environment at which the discrepancy exists.

19. The one or more non-transitory computer-readable storage media of claim 18, wherein the first representation is generated by application of a machine learning model to the sensor data, and wherein execution of the computer-executable instructions further causes the system to retrain the machine learning model based at least partly on the training data set.

20. The one or more non-transitory computer-readable storage media of claim 18, wherein determining the one or more discrepancies between the first representation and the second representation comprises:
comparing corresponding elements of the first representation and the second representation, wherein a first particular element of the first representation corresponds to a second particular element of the second representation; and
based on a determination that the first particular element indicates the first particular element is not occupied and the second particular element indicates that the second element is occupied, identifying a difference in classification between the first particular element and the second particular element.
